(19) United States
(12) Patent Application Publication
(10) Pub. No.: US 2022/0173491 A1
(43) Pub. Date: Jun. 2, 2022

(54) FIRE RESISTANT ANTENNA APPARATUSES, SYSTEMS AND METHODS

(71) Applicants: James Martin, Midland, TX (US); Rodney Joseph Perry, Ogden, UT (US)

(72) Inventors: James Martin, Midland, TX (US); Rodney Joseph Perry, Ogden, UT (US)

(21) Appl. No.: 17/368,821

(22) Filed: Jul. 6, 2021

Related U.S. Application Data
(60) Provisional application No. 62/705,546, filed on Jul. 3, 2020.

(51) Int. Cl. H01Q 1/00; H01Q 1/40; H01Q 1/38

(52) U.S. Cl. CPC H01Q 1/002; H01Q 1/38; H01Q 1/40

(57) ABSTRACT

An antenna or radiating element that is constructed of materials allowing for survivability of fire, high temperature, corrosive environments, or any combination of the aforementioned. Antennas are capable of operating for an extended period of time in a high temperature environment with the use of a radome having one or more surfaces covered in one or more of the following surface elements: a polyester film, a moldable plastic film, a boPET product, a ceramifiable silicone rubber material and a ceramic fiber wrap material. The surface elements can be used to construct a portion of the structural components of the antenna.

### CROSS-REFERENCES TO RELATED PATENT APPLICATIONS

This application claims benefit under U.S. Provisional Patent Application No. 62/705,546, filed on Jul. 3, 2020, which is hereby specifically incorporated by reference in its entirety into the present disclosure.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

Over time, wireless systems have become critical in communication systems, specifically communications systems dealing with public safety, marine, military, mining, commercial, governmental and other similar applications.

Previous national security events have resulted in a requirement to provide ubiquitous mobile radio coverage for First Responders (Fire, medical personnel, police, and the like) and it is commonplace to deploy ERRCS (Emergency Responder Radio Coverage Systems) that will provide wireless connectivity to these individuals inside buildings in the event of an emergency. These systems are typically the responsibility of the building owners or general contractors (in the case of a new building build), and these systems follow the deployment of several industry bodies such as the IFC (International Fire Council), NFPA (National Fire Protection Association, the SBC (Safer Buildings Coalition) and other industry organizations. Each of these bodies has developed guidelines that define the longevity and survivability of the cabling of the ERRCS systems in the event there is a fire in the building. There are several manufactures that are now manufacturing fire resistant coax cable that is suitable for use and that meets these various governing bodies with which the present embodiments can be used. These embodiments include various fire proof antennas that compliment and can be used with these prior art fire resistant coax cables, for example providing resiliency of the ERRCS in the event of a fire or other extreme temperature situations.

Typically, these systems are deployed with either a BDA/Coax distribution scheme or a Distributed Antenna System (DAS) that can distribute the signal to the various extents of the building or space that requires the enhancement, using a combination of fiber-optic and coaxial cabling or any other combination of transmission media known now or that could be used in the future such as fiber, CAT5/6, fiber, wireless DAS, and the like.

Embodiments of the inventive subject matter relate to systems, apparatuses and methods for manufacturing radomes and antennas structures that are fire resistant. More particularly, embodiments relate to radomes and antennas that have fire resistivity, and high temperature operating specifications and provide for connectivity and survivability during high temperature events. Other embodiments relate to radomes and antennas that have fire resistivity to environments having an element of steam including high temperature steam.

In addition, the antenna construction techniques listed here can be implemented in environments where a typical antenna would be limited in deployment capability. This includes corrosive and high humidity environments.

Also described is a coupling unit that would provide protection of the coax connector and the coupling element of the antenna. This coupling element provides corrosive protection as well as fire resistance in-line with the performance of the fire resistive antenna.

Radome constructions, or simply radomes, are electromagnetically transparent structures typically used for covering and protecting antennas and for radar systems. A typical antenna is a device capable of emitting, radiating, transmitting and/or receiving electromagnetic radiation. Some embodiments are used with radar systems and apparatuses. Radar is typically an object-detection system that uses radio waves to determine the range, angle, or velocity of objects. It is typically used to detect aircraft, ships, spacecraft, guided missiles, motor vehicles, weather formations, and terrain. A radar system usually consists of a transmitter producing electromagnetic waves in the radio or microwaves domain, a transmitting antenna, a receiving antenna (often the same antenna is used for transmitting and receiving) and a receiver and processor to determine properties of the object(s).

In some embodiments, a microwave antenna typically contains the following main elements: a feed antenna, a reflector dish, a shroud (i.e. a housing), the radome (i.e. the front protection cover) and mounting parts (e.g. mount, fixation parts). Examples of typical antennas include air surveillance radar antennas and satellite communication station antennas. Antennas and in particular large antennas such as radar installations, wireless telecom infrastructure and radio telescopes often need a covering structure, such as a radome to protect them from weather conditions, e.g. sunlight, wind and moisture. The presence of a radome is particularly essential for antennas placed in harsh environments such as in high winds or in storms often occur, in order to protect the antennas from debris. Prior art radome designs have addressed structural requirements such as aerodynamic shape, rigidity, and resistance to weather, shock, impact, vibrations and biodegradations, as well as electromagnetic transparency, e.g. a minimal reflection and/or absorption of passing electromagnetic energy, with a main purpose of minimizing an electromagnetic energy loss while at the same time protecting the antenna.

Structural requirements for radomes are usually met by using composite materials that generally have suitable mechanical properties. However, much of the material used in the prior art has a low tolerance for high heat, flames or corrosion. Much of this prior art is limited in its capacity to continuously provide wireless connectivity during fire events.

### SUMMARY

The illustrative embodiments provide for an antenna element that is capable of providing wireless connectivity during high temperature or other events that would degrade a traditional antenna design such as a design found in the prior art. This can include application in the following environments: inside or connected to a building, positioned on rooftops, positioned within industrial facilities, mines, plants, subways, tunnels, and the like.

One objective of embodiments of the inventive subject matter is to provide wireless coverage in an environment where there is high temperature, fire, chemical and corrosive or steam exposure.

Some embodiments include an antenna that is capable of operating for an extended period of time in a high temperature environment. These embodiments include a radome having one or more surfaces covered in one or more of the following surface elements: a polyester film, a moldable plastic film, a boPET product, a ceramifiable silicone rubber material and a ceramic fiber wrap material.

In many embodiments, the antenna is capable of operating for an extended period of time in a high temperature environment and the surface elements can be used to construct a portion of the structural components of the antenna. In some embodiments, the radome is constructed of a ceramic material. In other embodiments, silica aeroGel is used as an insulator in strategic locations inside the antenna. In yet other embodiments, silica aeroGel is used as an insulator in strategic locations external to the antenna including the surfaces of the antenna.

In many of the embodiments, the antenna is capable of operating for an extended period of time of more than one week.

In many embodiments, the antenna is capable of operating in a high temperature environment of more than fifty degrees Celsius. In some embodiments, the high temperature environment is caused by fire. In some embodiments, the high temperature environment is a corrosive environment. In some embodiments, the environment is a corrosive environment which can be a chemical based environment. In other embodiments, the high temperature environment is an environment having steam as an element.

### DETAILED DESCRIPTION OF THE DRAWINGS

The novel features of the inventive subject matter, both as to its structure and its operation, will be best understood from the accompanying drawings, taken in conjunction with the accompanying description, in which similar reference characters refer to similar parts, and in which:

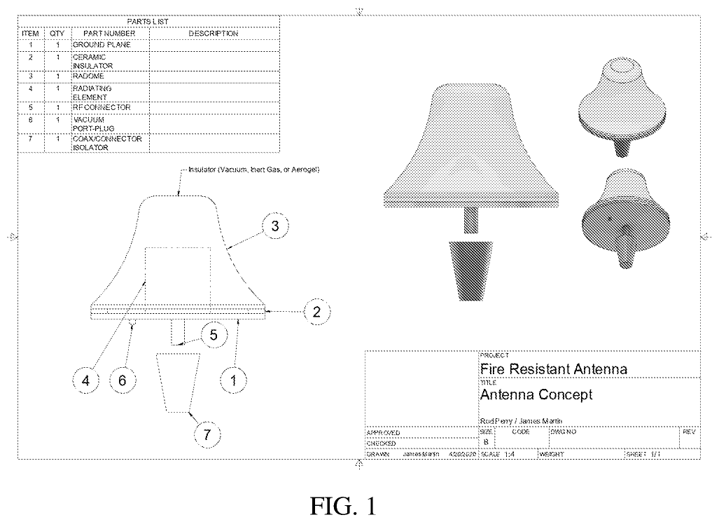

FIG. 1 is a plan view showing the elements according to embodiments of the inventive subject matter; and

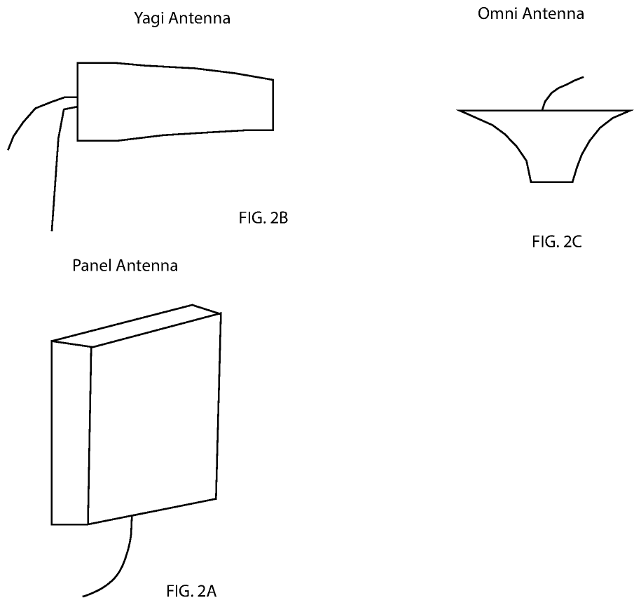

FIGS. 2A to 2C illustrate various radomes according the embodiments of the inventive subject matter.

### DETAILED DESCRIPTION

Turning to the figures, FIG. 1 illustrates a diagram of various components used in embodiments which allow for the operation of this system in temperature environments up to 1010° C. (1850° F.) for an extended period of time such as two hours. The period of time could be shorter than two hours or it could be longer. In these embodiments, fire resistant radomes and antennas are described.

FIG. 1. includes various elements including a radome 3, a radiating element 4, a coax to antenna sleeve 7 which couples the coax to the antenna and provides protection for the RF connector.

FIGS. 2A through 2C illustrate various configurations of radomes.

Embodiments may be made of a number of different materials including ceramic, or similar materials, which may be used in the construction of the internal radiating element and strategic other locations where high heat resistivity is required.

Other materials include ceramic fiber blankets & yarn which may be used as an internal insulator between a radome and a radiating element as well as other compartments or areas in the embodiments. Another material that may be used with embodiments is ceramifiable silicone which can be used as an insulator on coax and or antenna elements.

The various elements of the embodiments may be constructed of fiberglass, cellulose, polystyrene, carbon, carbon fiber, silica, polyurethane foam, and teflon. Other materials known to those skilled in the art which may be suitable for resistance to high temperature can also be used.

Additionally, embodiments may include insulators such as inert gas or a vacuum inside the radome. In other embodiments, silica aeroGel can be used as an insulator in strategic locations inside or externally to the antenna.

Embodiments may use any suitable type of antenna including but not limited to an omni directional, bi-directional, panel, or an enclosed array (also known as a Yagi) antenna.

The embodiments may be designed to be suitable for meeting building codes for a distributed antenna system (DAS) without the need for fire-protective soffits, conduits, or other expensive shielding.

Embodiments may also be partially constructed of a “ceramifiable” material, a material that turns from a flexible material into a ceramic when exposed to high temperatures, such as over 425° C., 482° C., 1010° C., or any similar material known to those skilled in the art.

The embodiments can be constructed of materials that have different melting ranges. For example, some low-melting temperature component materials may melt at 350° C. Other components may be used that melt between 425° C. and 482° C. while other component materials may be used that devitrify or pass from a glass-like state into a crystalline state. Additives may be used to bond components together providing additional resistance to extreme temperatures. Some components may be made of materials that can be configured to convert from a resilient elastomer to a porous ceramic when heated above 425°.

Any ceramifiable material such as silicone rubber having silicone polymer (polysiloxane) with additives may be used. These additives can be used to cause the material to turn into a fire-resistant ceramic in high temperature fire conditions. These embodiments may include peroxide crosslinking or condensation-crosslinking high consistency silicone rubber. A silicone polymer matrix can include low-melting point inorganic flux particles and refractory filler particles in a polysiloxane matrix.

Other embodiments may use ceramic wraps to maintain structural integrity of the components at high temperatures. Refractory materials may also be used in embodiment, for example non-metallic material having those chemical and physical properties that make them applicable for structures, or as components of systems, that are exposed to environments above 1,000° F. (811 K; 538° C.) (ASTM C71), or the like.

Other embodiments may be partially constructed of a thermoplastic or thermoset compounds that emit low amounts of smoke and/or halogen when exposed to high sources of heat.

In the described embodiments, the structure of the radome may be of any suitable thickness and the surfaces may be covered in any suitable substance such as MYLAR® polyester film (a trade name of E. I. du Pont de Nemours and Company, Wilmington, Del., U.S.A.), MELINEX® (a moldable plastic film produced by Imperial Chemical Industries Ltd. Corp. of London, U.K.) and Hostaphan (another boPET type of product produced by Hoechst Aktiengesellschaft Corp. of Frankfurt, Germany).

In some embodiments, the ceramifiable silicone rubber material can be used. In other embodiments, ceramic fiber wrap material may be used for all or a portion of the structural components. During a building fire, explosion, or other emergency, the antenna may be exposed to high temperatures with the ceramifiable silicone rubber or ceramic fiber wrap surrounding the outer surfaces of the components can maintain their forms and structural integrity. The ceramic matrix from the ceramified silicone rubber, or the ceramic fiber wrap, can be designed to not allow the electrical components to electrically short against other surfaces.

In some embodiments, metalized braids and/or MYLAR® tape can be used to wrap or encase other components. Other non-metalized layers may be used to prevent further metal on metal contact in high temperature settings. In some embodiments, a ceramic fiber wrap may be constructed of refractory aluminoborosilicate, aluminosilica, or alumina. Either ceramifiable silicone rubber-based or ceramic fiber wrap-based refractory insulating components can be used to resist high temperatures.

Additionally, one or more layers of temperature resistant materials such as ceramifiable silicone rubber may be used to build up layers to form suitable thickness for temperature protection.

Although specific embodiments have been described, various modifications, alterations, alternative constructions, and equivalents are also encompassed within the scope of the inventive subject matter. The described embodiments are not restricted to operation within a certain specific environment, but instead are free to operate within any type of environment. Additionally, although method embodiments of the present inventive subject matter have been described using a particular series of and steps, it should be apparent to those skilled in the art that the scope of the inventive subject matter is not limited to the described series of transactions and steps.

Further, while embodiments of the present inventive subject matter have been described using a particular combination of hardware, it should be recognized that other combinations of hardware are also within the scope of the present inventive subject matter. The specification and drawings are, accordingly, to be regarded in an illustrative rather than a restrictive sense. It will, however, be evident that additions, subtractions, deletions, and other modifications and changes may be made thereunto without departing from the broader spirit and scope of the inventive subject matter.

What is claimed is:

1. An antenna capable of operating for an extended period of time in a high temperature environment comprising a radome having one or more surfaces covered in one or more of the following surface elements: a polyester film, a moldable plastic film, a boPET product, a ceramifiable silicone rubber material and a ceramic fiber wrap material.

2. The antenna capable of operating for an extended period of time in a high temperature environment of claim 1 wherein the surface elements can be used to construct a portion of the structural components of the antenna.

3. The antenna capable of operating for an extended period of time in a high temperature environment of claim 1 wherein the radome is constructed of a ceramic material.

4. The antenna capable of operating for an extended period of time in a high temperature environment of claim 1 wherein silica aeroGel is used as an insulator in one or more locations inside the antenna.

5. The antenna capable of operating for an extended period of time in a high temperature environment of claim 1 wherein silica aeroGel is used as an insulator in one or more locations external to the antenna including one or more surfaces of the antenna.

6. The antenna capable of operating for an extended period of time in a high temperature environment of claim 1 wherein the antenna is capable of operating for more than one week.

7. The antenna capable of operating for an extended period of time in a high temperature environment of claim 1 wherein the antenna is capable of operating in a high temperature environment of more than fifty degrees Celsius.

8. The antenna capable of operating for an extended period of time in a high temperature environment of claim 1 wherein the high temperature environment is caused by fire.

9. The antenna capable of operating for an extended period of time in a high temperature environment of claim 1 wherein the high temperature environment is a corrosive environment.

10. The antenna capable of operating for an extended period of time in a high temperature environment of claim 9 wherein the corrosive environment is a chemical environment.

11. The antenna capable of operating for an extended period of time in a high temperature environment of claim 1 wherein the high temperature environment is an environment having steam as an element.

12. A system for operating an antenna over an extended period of time in a high temperature environment comprising a radome having one or more surfaces covered in one or more of the following surface elements: a polyester film, a moldable plastic film, a boPET product, a ceramifiable silicone rubber material and a ceramic fiber wrap material.

13. The system for operating an antenna over an extended period of time in a high temperature environment of claim 12 wherein the surface elements can be used to construct a portion of the structural components of the antenna.

14. The system for operating an antenna over an extended period of time in a high temperature environment of claim 12 wherein the radome is constructed of a ceramic material.

15. The system for operating an antenna over an extended period of time in a high temperature environment of claim 12 wherein silica aeroGel is used as an insulator in one or more locations inside the antenna.

16. The system for operating an antenna over an extended period of time in a high temperature environment of claim 12 wherein silica aeroGel is used as an insulator in one or more locations external to the antenna including one or more surfaces of the antenna.

17. A method of operating an antenna over an extended period of time in a high temperature environment comprising the step of using a radome to transmit and receive signals wherein the radome has one or more surfaces covered in one or more of the following surface elements: a polyester film, a moldable plastic film, a boPET product, a ceramifiable silicone rubber material and a ceramic fiber wrap material.

18. The method of operating an antenna over an extended period of time in a high temperature environment of claim 17 wherein the surface elements can be used to construct a portion of the structural components of the antenna.

19. The method of operating an antenna over an extended period of time in a high temperature environment of claim 17 wherein the radome is constructed of a ceramic material.

20. The method of operating an antenna over an extended period of time in a high temperature environment of claim 17 silica aeroGel is used as an insulator in one or more locations inside the antenna.
